(19) United States
(12) Patent Application Publication
(10) Pub. No.: US 2016/0341266 A1
(43) Pub. Date: Nov. 24, 2016

(54) Brake Assembly Having a Grooved Camshaft

(71) Applicant: ArvinMeritor Technology, LLC, Troy, MI (US)

(72) Inventor: Joshua R. Oliver, Auburn Hills, MI (US)

(21) Appl. No.: 14/714,631

(22) Filed: May 18, 2015

(51) Int. Cl. F16D 51/28; F16D 65/22

(52) U.S. Cl. CPC F16D 51/28; F16D 65/22; F16D 2125/30

(57) ABSTRACT

A brake assembly having a camshaft for actuating a brake pad assembly. The camshaft may have an S-cam that has a contact groove that may receive a cam roller. The cam roller may be disposed adjacent to the contact groove when the camshaft is in a first rotational position and may be received in the contact groove when the camshaft is in a second rotational position.

### TECHNICAL FIELD

This patent application relates to a brake assembly that may have a camshaft that may have a contact groove that may receive a cam roller.

### BACKGROUND

A brake assembly having a camshaft is disclosed in U.S. Patent Publication No. 2014/0262643.

### SUMMARY

In at least one embodiment, a brake assembly is provided. The brake assembly may include a spider, a brake pad assembly that may be moveably disposed on the spider, a camshaft, and a cam roller. The camshaft may be disposed proximate the spider and may rotate about an axis to actuate the brake pad assembly. The camshaft may have an S-cam that may have an end surface, a first end wall, and a contact groove. The first end wall may extend from the end surface. The contact groove may extend from the first end wall and may be disposed closer to the axis than the first end wall. The cam roller may engage the S-cam and may support the brake pad assembly. The cam roller may be received in the contact groove when the camshaft is in a second rotational position.

In at least one embodiment, a brake assembly is provided. The brake assembly may include a spider, a brake pad assembly, a camshaft tube, a camshaft, and a cam roller. The brake pad assembly may be moveably disposed on the spider. The camshaft tube may be mounted to the spider. The camshaft may be disposed in the camshaft tube and may rotate about an axis to actuate the brake pad assembly. The camshaft may include a shaft and an S-cam. The shaft may be rotatably disposed in the camshaft tube and may have an outer shaft surface that may extend around the axis. The S-cam may be disposed proximate an end of the shaft. The S-cam may have an end surface, a first end wall, and a contact groove. The first end wall may have a first arcuate surface that may extend from the end surface. The contact groove may extend from the first end wall toward the shaft. The contact groove may be disposed closer to the axis than the first arcuate surface and the outer shaft surface. The cam roller may engage the S-cam and the brake pad assembly and may be not be received in the contact groove when the camshaft is in a first rotational position and may be received in the contact groove when the camshaft is rotated from the first rotational position to a second rotational position.

### BRIEF DESCRIPTION OF THE DRAWINGS

FIG. 1 is a perspective view of a brake assembly.

FIG. 2 is a perspective view of a cam roller that may be provided with the brake assembly.

FIG. 3 is a perspective view of a portion of a camshaft that may be provided with the brake assembly.

FIG. 4 is a side view of the brake assembly with the camshaft in a first rotational position.

FIG. 5 is a side view of the brake assembly with the camshaft between the first and second rotational positions.

FIG. 6 is a side view of the brake assembly with the camshaft in a second rotational position.

FIG. 7 is a section view of the brake assembly along section line 7-7.

FIG. 8 is a front section view of the brake assembly with the camshaft in the first rotational position.

FIG. 9 is a front section view of the brake assembly with the camshaft in the second rotational position.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

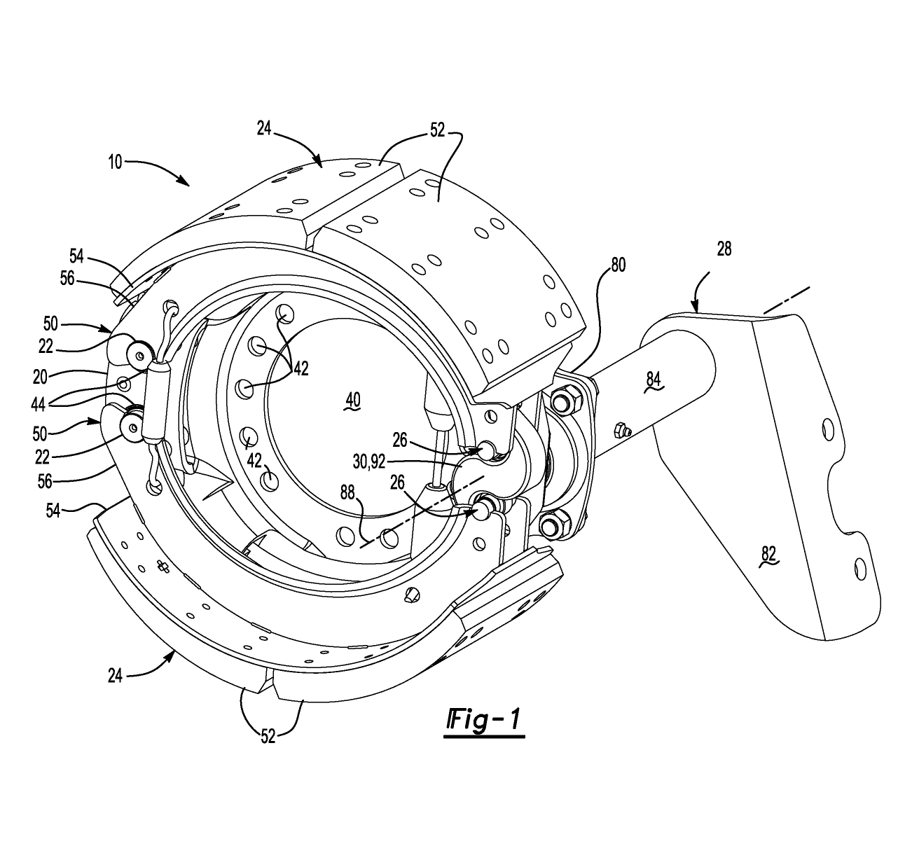

Referring to FIG. 1, an exemplary brake assembly 10 is shown. The brake assembly 10 may be provided with a vehicle, such as a motor vehicle like a truck, bus, farm equipment, mining equipment, military transport or weaponry vehicle, or cargo loading equipment for land, air, or marine vessels. In addition, the brake assembly 10 may be provided on a trailer that may be coupled to or provided with a motor vehicle.

The brake assembly 10 may be a friction brake that may be configured to slow or inhibit rotation of at least one associated wheel. In FIG. 1, the brake assembly 10 has a drum brake configuration. In a drum brake configuration, a brake drum may extend continuously around brake pad assemblies that may be configured to engage the brake drum to slow the rotation of a wheel that is associated with the brake drum. The brake drum may be disposed between a wheel and a wheel hub assembly that may rotatably support the wheel. In at least one embodiment, the brake assembly 10 may include a spider 20, an anchor pin 22, a brake pad assembly 24, a cam roller 26, a bracket assembly 28, and a camshaft 30.

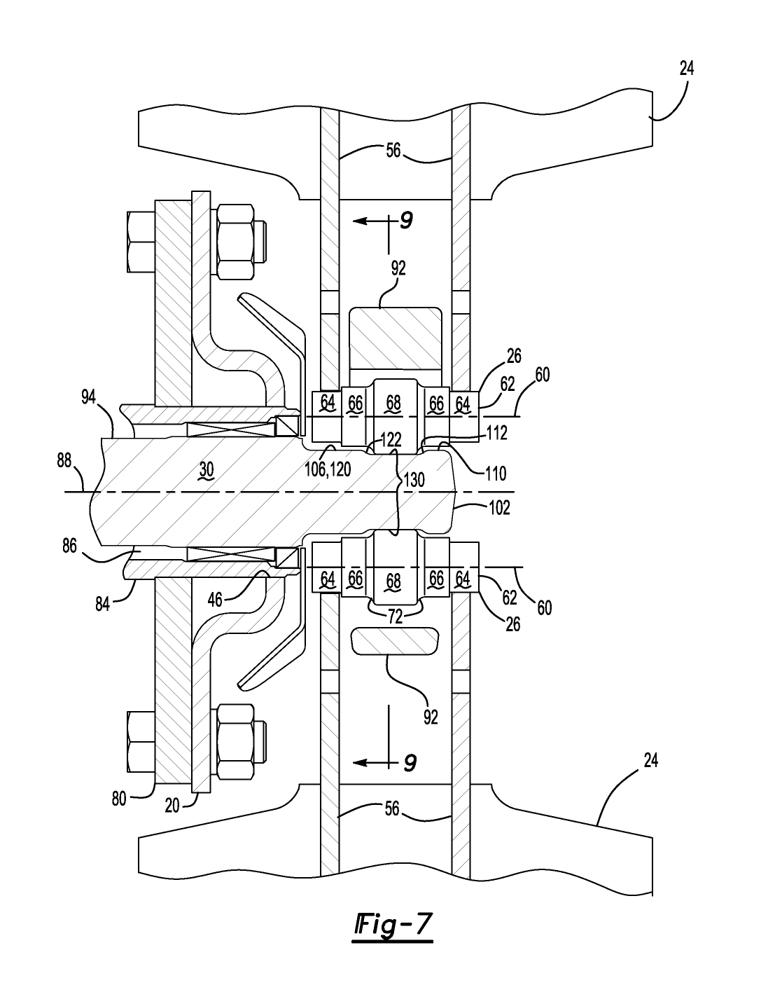

The spider 20 may support components of the brake assembly 10. In addition, the spider 20 may facilitate mounting of the brake assembly 10 to the vehicle. For example, the spider 20 may be fixedly disposed on or fixedly positioned with respect to an axle assembly or a steering knuckle. In at least one embodiment, the spider 20 may include an opening 40 through which an axle and/or a spindle may extend. For example, a spindle may extend through the opening 40 and may support one or more wheel bearings that may support and facilitate rotation of a wheel. The spider 20 may also include at least one spider mounting hole 42, at least one anchor pin hole 44, and a camshaft opening 46, which is best shown in FIG. 7.

A spider mounting hole 42 may facilitate mounting of the spider 20 to the vehicle. A plurality of spider mounting holes 42 may be arranged around the opening 40. Each spider mounting hole 42 may receive a fastener, such as a bolt, that may extend through the spider mounting hole 42 and couple the spider 20 to another component, such as an axle assembly or a steering knuckle.

The anchor pin hole 44 may receive an anchor pin 22 that may facilitate mounting and operation of a brake pad assembly 24 will be discussed in more detail below. In FIG. 1, two anchor pin holes 44 are provided that are generally disposed opposite the bracket assembly 28. Each anchor pin hole 44 may receive a different anchor pin 22 and each anchor pin 22 may support a corresponding brake pad assembly 24.

The camshaft opening 46 may receive the camshaft 30 and optionally a portion of the bracket assembly 28. The camshaft 30 may extend through the camshaft opening 46 to engage one or more brake pad assemblies 24.

Referring to FIGS. 1-3, the anchor pin 22 may support and facilitate mounting of at least one brake pad assembly 24 to the spider 20. The anchor pin 22 may be integrally formed with the spider 20 or may be provided as a separate component. The anchor pin 22 may be received in the anchor pin hole 44 if provided as a separate component and may be fixedly positioned with respect to the spider 20 in one or more embodiments. The anchor pin 22 may protrude from opposite ends of the anchor pin hole 44 or opposite sides of the spider 20 to pivotally support a brake pad assembly 24.

One or more brake pad assemblies 24 may be provided to slow or inhibit the rotation of a wheel. In FIG. 1, two brake pad assemblies 24 are shown that may be generally disposed opposite each other. The brake pad assemblies 24 may be disposed proximate the spider 20 and may move with respect to the spider 20. Each brake pad assembly 24 may include a brake shoe 50 and a friction material 52.

The brake shoe 50 may be pivotally mounted to the spider 20 at a first end via an anchor pin 22. For example, the anchor pin 22 may be fixedly positioned with respect to the spider 20 and the brake shoe 50 may pivot about an outer surface or circumference of the anchor pin 22 when the brake pad assembly 24 is actuated. An opposite end of the brake shoe 50 may have a groove that may receive a cam roller 26 that may be configured to engage a cam of the camshaft 30.

The brake shoe 50 may be a structural member of a brake pad assembly 24 and may facilitate mounting of the brake pad assembly 24 to the spider 20. The brake shoe 50 may include a table 54 that may be configured to support the friction material 52 and at least one web 56.

Referring to FIGS. 1 and 7, at least one web 56 may extend from the table 54. In FIG. 7, a pair of webs 56 is shown that extend from the table 54 such that the webs 56 are spaced apart from each other. The webs 56 may have the same or similar configurations. The webs 56 may be mounted to the table 54 in any suitable manner, such as by welding or with one or more fasteners. Each web 56 may have a first end that may be disposed proximate the anchor pin 22 and a second end that may be disposed proximate the cam roller 26.

The friction material 52, which may also be called a brake lining, may be disposed on an outer surface of the table 54 and may face toward the brake drum. The friction material 52 may engage the brake drum during vehicle braking and may be spaced apart from the brake drum when the friction braking is not being applied.

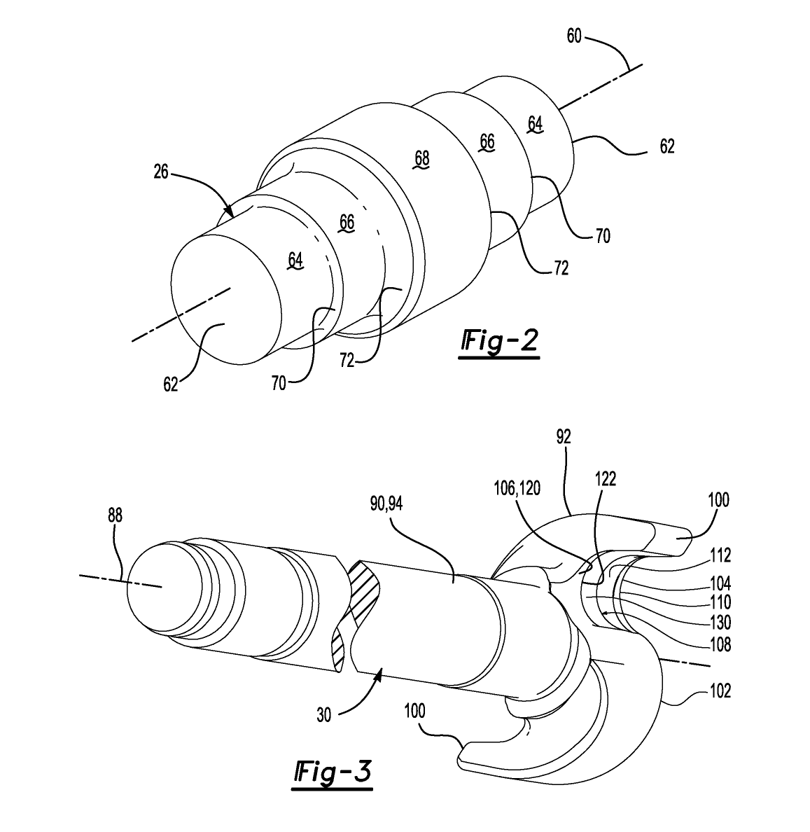

The cam roller 26 may be disposed between the brake pad assembly 24 and the camshaft 30. For example, the cam roller 26 may engage the camshaft 30 and the brake shoe 50 and may support the brake pad assembly 24. A cam roller 26 may be associated with each brake pad assembly 24 and the cam rollers 26 may be disposed on opposite sides of the camshaft 30 and its axis of rotation. As is best shown in FIG. 2, the cam roller 26 may extend along a cam roller axis 60 and may have a cam roller end surface 62, a brake shoe engagement surface 64, an intermediate surface 66, a cam engagement surface 68, a first step surface 70, and a second step surface 72.

The cam roller end surface 62 may be disposed at an end of the cam roller 26. In the embodiment shown, a pair of cam roller end surfaces 62 are provided that may be disposed at opposite ends of the cam roller 26 and extend from the cam roller axis 60. The cam roller end surface 62 may extend substantially perpendicular with respect to the cam roller axis 60. The cam roller 26 may be optional in one or more embodiments, such as when the brake shoe 50 directly engages the S-cam of the camshaft 30. Alternatively, the cam roller 26 may be part of the brake shoe 50 and may not rotate with respect to the brake shoe 50, thereby resulting in sliding contact rather than a rolling contact with the camshaft 30.

The brake shoe engagement surface 64 may engage and support the brake shoe 50 of the brake pad assembly 24. In FIG. 2, a pair of brake shoe engagement surfaces 64 is provided such that each brake shoe engagement surface 64 may extend from a corresponding cam roller end surface 62 toward the intermediate surface 66. The brake shoe engagement surface 64 may extend continuously around the cam roller axis 60. For example, the brake shoe engagement surface 64 may be an outer circumferential surface of the cam roller 26 that may be radially disposed with respect to the cam roller axis 60. The brake shoe engagement surface 64 may have a smaller diameter than the intermediate surface 66 and the cam engagement surface 68. As is best shown in FIG. 7, each brake shoe engagement surface 64 may engage a corresponding web 56 of the brake shoe 50. In addition, the brake shoe engagement surface 64 may be completely spaced apart from and may not engage the camshaft 30 in one or more embodiments.

The intermediate surface 66 may be disposed between the brake shoe engagement surface 64 and the cam engagement surface 68. In FIG. 2, a pair of intermediate surfaces 66 is provided in which the intermediate surfaces 66 are disposed on opposite sides of the cam engagement surface 68. Each intermediate surface 66 may extend continuously around the cam roller axis 60. For example, the intermediate surface 66 may be an outer circumferential surface of the cam roller 26 that may be radially disposed with respect to the cam roller axis 60. The intermediate surface 66 and may have a larger diameter than the brake shoe engagement surface 64.

The cam engagement surface 68 may engage the camshaft 30. The cam engagement surface 68 may be axially disposed between the pair of brake shoe engagement surfaces 64 and/or between the pair of intermediate surfaces 66. The cam engagement surface 68 may extend continuously around the cam roller axis 60. The cam engagement surface 68 may be an outer circumferential surface of the cam roller 26 that may be radially disposed with respect to the cam roller axis 60. The cam engagement surface 68 may have a larger diameter than the brake shoe engagement surface 64 and the intermediate surface 66. As is best shown in FIG. 7, the cam engagement surface 68 may be disposed between and may be spaced apart from the webs 56 of the brake shoe 50. The cam engagement surface 68 may be completely spaced apart from and may not engage the brake shoe engagement surface 64, the intermediate surface 66, and the brake pad assembly 24 in one or more embodiments. In addition, the cam engagement surface 68 may be the only surface of the cam roller 26 that may engage the camshaft 30.

The first step surface 70 may extend from the brake shoe engagement surface 64 to the intermediate surface 66. The first step surface 70 or a portion thereof may extend substantially perpendicular to the cam roller axis 60 in one or more embodiments. In FIG. 2, a pair of first step surfaces 70 is provided. Each first step surface 70 may be disposed proximate and may engage a corresponding brake pad assembly 24. For instance, a first step surface 70 may engage a corresponding web 56 of the brake shoe 50 to inhibit axial movement of the brake shoe 50 with respect to the cam roller axis 60.

The second step surface 72 may extend from the intermediate surface 66 to the cam engagement surface 68. The second step surface 72 or a portion thereof may extend substantially perpendicular to the cam roller axis 60 in one or more embodiments. In FIG. 2, a pair of second step surfaces 72 is provided. The second step surfaces 72 may extend into or may be received in a corresponding contact groove in the camshaft 30 as will be discussed in more detail below. Optionally, a second step surface 72 may engage the camshaft 30 to limit or inhibit axial movement of the camshaft 30 with respect to the brake shoe 50.

Referring to FIGS. 1 and 7, the bracket assembly 28 may facilitate mounting of the camshaft 30 and one or more components associated with actuation of the camshaft 30. The bracket assembly 28 may include a mounting flange 80, a brake wing 82, and a camshaft tube 84. In at least one embodiment, the mounting flange 80, brake wing 82, and camshaft tube 84 may be provided as separate components. It is also contemplated that the mounting flange 80 may be integrally formed with the camshaft tube 84 or the brake wing 82 may be integrally formed with the camshaft tube 84, thereby resulting in a two piece bracket assembly configuration. As is best shown in FIG. 7, the bracket assembly 28 may have a hole 86 that may receive the camshaft 30. The hole 86 may be a through hole that may extend through the bracket assembly 28. The hole 86 may extend along an axis 88 and may be defined by the camshaft tube 84 and optionally by hole portions in the mounting flange 80 and/or the brake wing 82.

The mounting flange 80 may facilitate mounting of the bracket assembly 28 to the spider 20. The mounting flange 80 may be spaced apart from the brake wing 82 and may be fixedly coupled to the camshaft tube 84.

The brake wing 82 may be coupled to the camshaft tube 84 and may support an actuator that may actuate or rotate the camshaft 30 about the axis 88. The brake wing 82 may be spaced apart from the spider 20 and may be fixedly coupled to the camshaft tube 84 opposite the mounting flange 80.

The camshaft tube 84 may extend from the mounting flange 80 to the brake wing 82. The camshaft tube 84 may have a generally tubular configuration and may define at least a portion of the hole 86 through which the camshaft 30 may extend. The camshaft tube 84 may interconnect the mounting flange 80 and the brake wing 82 and may be disposed around the axis 88

Referring to FIGS. 1 and 3, the camshaft 30 may be configured to actuate the brake pad assemblies 24. The camshaft 30 may be disposed proximate the spider 20 and may extend along and may rotate about the axis 88. For example, the camshaft 30 may extend through the camshaft opening 46 in the spider 20 and the hole 86 in the bracket assembly 28. In at least one embodiment, the camshaft 30 may include a shaft 90 and an S-cam 92.

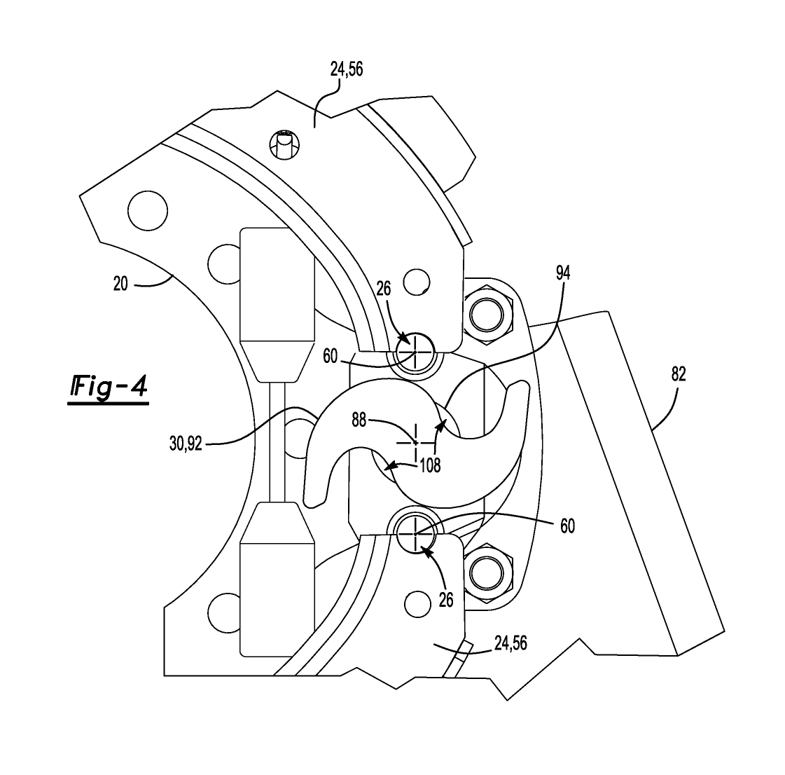

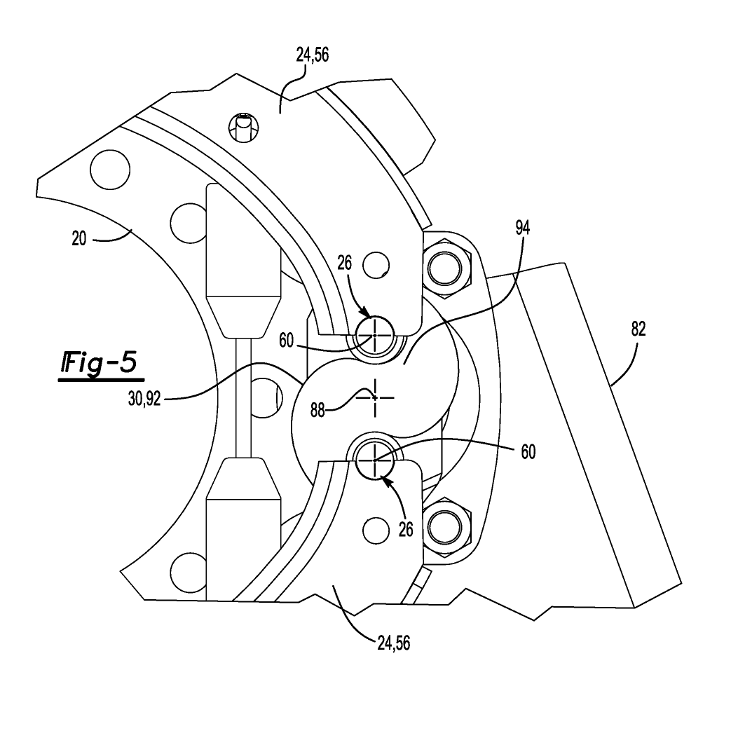

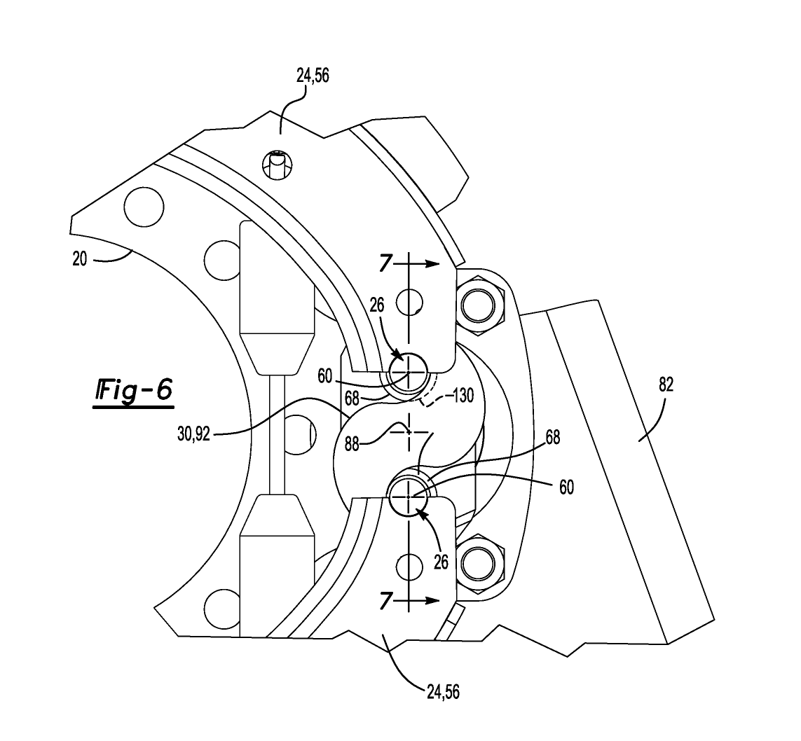

The shaft 90 may be rotatably disposed in the camshaft tube 84 and may extend along the axis 88. The shaft 90 may have a first end and a second end that may extend out of opposite ends of the camshaft tube 84. The first end of the camshaft 30 may be disposed proximate and may engage a slack adjuster that may compensate for brake wear or wear of the friction material 52. For example, the slack adjuster may have a mounting hole that may receive the first end of the camshaft 30. The slack adjuster may be coupled to an actuator that may actuate the camshaft 30 about the axis 88. The actuator may move between a retracted position and an extended position. In the extended position, the actuator may rotate the camshaft 30 in a first rotational direction about the axis 88 toward a first rotational position as shown in FIG. 4 and actuate the brake pad assemblies 24 to move toward and engage the brake drum to inhibit rotation of an associated wheel. In the retracted position, the camshaft 30 may rotate in a second rotational direction about the axis 88 toward a second rotational position as shown in FIG. 6 to allow the brake pad assemblies 24 to disengage the brake drum and may permit rotation of an associated wheel. The actuator may be of any suitable type, such as a pneumatic, hydraulic, electrical, or electromechanical actuator.

As is best shown in FIGS. 3 and 7, the shaft 90 may have an outer shaft surface 94. The outer shaft surface 94 may extend continuously around the axis 88 between opposing ends of the camshaft 30. The outer shaft surface 94 may be an outer circumferential surface of the shaft 90 that may be radially disposed with respect to the axis 88.

Referring to FIGS. 3 and 7, the S-cam 92 may be disposed proximate the second end of the shaft 90. The S-cam 92 may be configured to engage the cam roller 26. An S-cam may have a configuration that resembles the letter S when viewed axially or from an end of the axis 88. Such a configuration may include a pair of cam arms 100 that are each configured to engage a corresponding cam roller 26.

An end surface 102 may be disposed at an end of the S-cam 92. The end surface 102 may at least partially define each cam arm 100 and extend away from the axis 88 or generally perpendicular to the axis 88. In at least one embodiment, each cam arm 100 may extend the end surface 102 and may have a first end wall 104, a second end wall 106, and a contact groove 108.

The first end wall 104 may be disposed proximate the end surface 102. For example, the first end wall 104 may extend from the end surface 102 and may be at least partially defined by the end surface 102. The first end wall 104 may at least partially define the contact groove 108. The first end wall 104 may also include or may be at least partially defined by a first arcuate surface 110 and a first side surface 112.

The first arcuate surface 110 may extend from the end surface 102 toward the shaft 90. The first arcuate surface 110 or a portion thereof may be disposed substantially perpendicular to the end surface 102 and/or extend substantially parallel to the axis 88 in one or more embodiments. As is best shown in FIG. 7, the first arcuate surface 110 may face toward and may be disposed substantially parallel to at least a portion of the intermediate surface 66 of a corresponding cam roller 26.

The first side surface 112 may extend from the first arcuate surface 110 toward the axis 88. In addition, the first side surface 112 may face toward the second step surface 72 of a corresponding cam roller 26. The first side surface 112 may be spaced apart from and may not engage the second step surface 72 when the camshaft 30 is in a nominal or normal axial position or position along the axis 88; however, it is contemplated that the first side surface 112 may engage a portion of the first end wall 104, such as the first side surface 112, to inhibit axial movement of the camshaft 30 with respect to the cam roller 26 or vice versa. For instance, the first side surface 112 may engage the second step surface 72 if the camshaft 30 to the left from the perspective shown in FIG. 7 or the cam roller 26 moves to the right from the perspective shown.

The second end wall 106, if provided, may be disposed proximate the shaft 90. For example, the second end wall 106 may extend from the shaft 90 toward the first end wall 104. The second end wall 106 may at least partially define the contact groove 108. The second end wall 106 may also include or may be at least partially defined by a second arcuate surface 120 and a second side surface 122.

The second arcuate surface 120 may extend from the shaft 90 toward the end surface. The second arcuate surface 120 may have substantially the same profile as the first arcuate surface 110 and may be aligned with or disposed substantially parallel to the first arcuate surface 110. As such, the second arcuate surface 120 or a portion thereof may be disposed extend substantially parallel to the axis 88 in one or more embodiments. As is best shown in FIG. 7, the second arcuate surface 120 may face toward and may be disposed substantially parallel to at least a portion of the brake shoe engagement surface 64 and/or the intermediate surface 66 of a corresponding cam roller 26 between the shaft 90 and the cam engagement surface 68. In addition, the first arcuate surface 110 and the second arcuate surface 120 may be disposed closer to the axis 88 than the outer shaft surface 94 as is best shown in FIG. 7.

The second side surface 122 may extend from the second arcuate surface 120 toward the axis 88. The second side surface 122 may be disposed opposite the first side surface 112 and may face toward the second step surface 72 of a corresponding cam roller 26. The second side surface 122 may be spaced apart from and may not engage the second step surface 72 when the camshaft 30 is in a nominal or normal axial position or position along the axis 88; however, it is contemplated that the second side surface 122 may engage a portion of the second end wall 106, such as the second step surface 72, to inhibit axial movement of the camshaft 30 with respect to the cam roller 26 or vice versa. For instance, the second side surface 122 may engage the second step surface 72 if the camshaft 30 to the right from the perspective shown in FIG. 7 or the cam roller 26 moves to the left from the perspective shown.

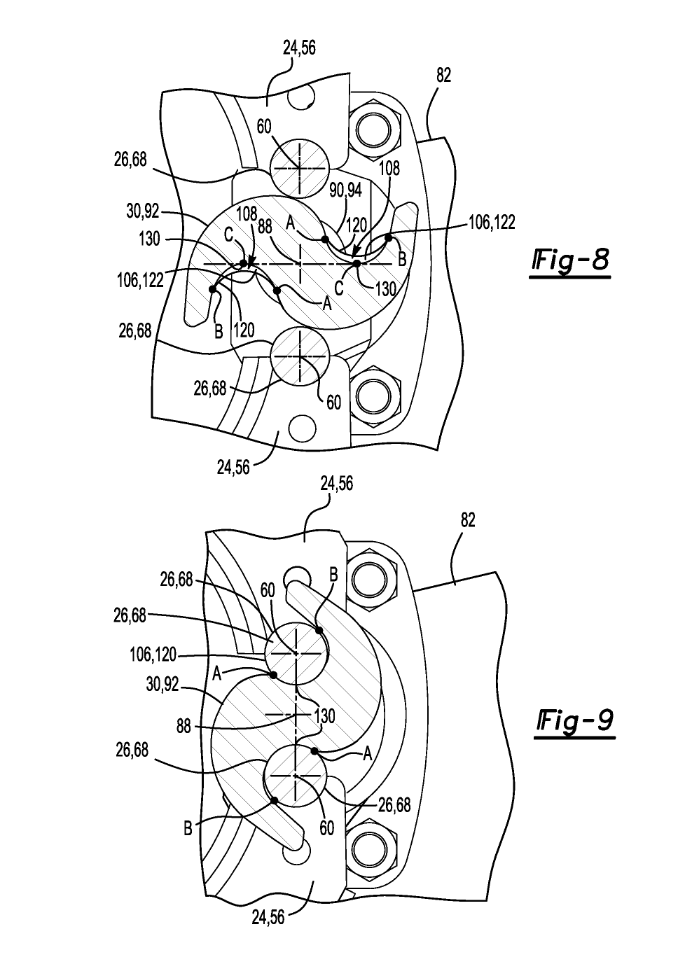

The contact groove 108 may be configured as a groove or recess that may be provided in the S-cam 92 and that may extend toward the axis 88. The contact groove 108 may be at least partially defined by the first end wall 104 and the second end wall 106. For example, a contact surface 130 may extend from the first end wall 104 to the second end wall 106 to define a bottom of the contact groove 108. For example, the contact surface 130 may be a concave surface that may extend from the first side surface 112 to the second side surface 122. The contact groove 108 may be disposed closer to the axis 88 than the first end wall 104 and/or the second end wall 106. For instance, the contact groove 108 may be recessed with respect to the first arcuate surface 110 and the second arcuate surface 120 such that the contact surface 130 may be disposed closer to the axis 88 than the first arcuate surface 110 and the second arcuate surface 120. As is best shown in FIGS. 8 and 9, the contact surface 130 may extend from point A to point B. Points A and B may represent lines that may be disposed substantially parallel to the axis 88 and that may coincide with opposite ends of the first arcuate surface 110 and/or the second arcuate surface 120. The contact surface 130 may have a different curvature or radius of curvature than the first arcuate surface 110 and the second arcuate surface 120. In addition, the contact surfaces 130 of each contact groove 108 may have inflection points C that may be coplanar with each other and/or the axis 88 as shown in FIG. 8. The contact groove 108 and the contact surface 130 may be disposed closer to the axis 88 than the outer shaft surface 94 as is best shown in FIG. 7.

Referring to FIGS. 4-6, 8, and 9 operation of the brake assembly 10 is shown in more detail.

In FIGS. 4 and 8, the camshaft 30 is shown in an exemplary first rotational position. In the first rotational position, the cam rollers 26 may be disposed adjacent to a corresponding contact groove 108 but may not be received in a corresponding contact groove 108. As such, the cam engagement surface 68 may not engage the contact surface 130. Optionally, the cam roller 26 may be received in a corresponding contact groove 108 when in the first rotational position in one or more embodiments, such as when the contact groove 108 may have a greater length. Moreover, the brake pad assemblies 24 may be actuated away from each other to engage a brake drum or inhibit rotation of an associated wheel when the camshaft 30 is in the first rotational position.

In FIG. 5, the camshaft 30 is rotated about the axis 88 to a position between the first rotational position shown in FIG. 4 and the second rotational position shown in FIG. 6. More specifically, the camshaft 30 is rotated counterclockwise about the axis 88 from the position shown in FIG. 4. Rotation of the camshaft 30 about the axis 88 may allow the cam rollers 26 to enter a corresponding contact groove 108. More specifically, the cam roller 26 may rotate about the cam roller axis such that the cam engagement surface 68 may roll into and may be received in the contact groove 108 and may roll along the contact surface 130 toward a distal end of a corresponding cam arm 100. As such, each cam roller 26 may move closer to the axis 88, which in turn may allow the brake pad assemblies 24 to pivot about a corresponding anchor pin 22 and move toward the axis 88 and away from the brake drum.

In FIGS. 6, 7, and 9, the camshaft 30 is rotated about the axis 88 to the second rotational position. More specifically, the camshaft 30 is rotated counterclockwise about the axis 88 from the position shown in FIG. 5. Rotation of the camshaft about the axis 88 may allow the cam rollers 26 to further enter a corresponding contact groove 108 and move closer to the axis 88 to allow the brake pad assemblies 24 to further pivot about a corresponding anchor pin 22 to a fully refracted position. The intermediate surfaces 66 of the cam roller 26 may be disposed proximate the first arcuate surface 110 and/or the second arcuate surface 120 when the camshaft 30 is in the second rotational position. As such, each cam roller 26 may be received in the contact groove 108 when the camshaft 30 is rotated from the first rotational position to a second rotational position and the camshaft 30 may be disposed closer to the axis 88 when the camshaft 30 is in the second rotational position than when the camshaft 30 is in the first rotational position. As shown in FIG. 7, the cam roller 26 may be disposed between and may be spaced apart from the first side surface 112 and the second side surface 122 when the cam roller 26 is disposed in the contact groove 108 and/or is disposed in the second rotational position.

The camshaft 30 may be rotated about the axis 88 from the second rotational position toward the first rotational position to brake a vehicle wheel. Rotation of the camshaft 30 in a first rotational direction from the position shown in FIG. 6 to the position shown in FIG. 4 may occur in response to force exerted by the actuator and may actuate the brake pad assemblies 24 such that the friction material 52 moves toward or engages an inner surface of the brake drum to brake or slow or inhibit rotation of an associated wheel.

Providing a camshaft 30 with an S-cam that has a contact groove may allow additional friction material to be provided with a brake pad assembly as compared to a camshaft that does not have a contact groove. More specifically, the contact groove may allow the contact surface to be located closer to the axis and the S-cam base radius, which may allow a brake pad assembly to move closer to the axis or be retracted a greater distance from the brake drum as compared to similarly configured S-cam that does not have a contact groove. The greater retraction distance of the brake pad assembly may allow additional friction material or friction material having a greater thickness to be provided without changing the size or configuration of the brake shoe and without changing the size or configuration of the brake drum. Providing additional friction material may increase brake pad assembly life or the amount of braking cycles that can be executed prior to replacement, thereby reducing servicing intervals and maintenance costs.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A brake assembly comprising:
a spider;
a brake pad assembly that is moveably disposed on the spider;
a camshaft that is disposed proximate the spider and that rotates about an axis to actuate the brake pad assembly, wherein the camshaft has an S-cam that has an end surface, a first end wall that extends from the end surface, and a contact groove that extends from the first end wall, wherein the contact groove is disposed closer to the axis than the first end wall; and
a cam roller that engages the S-cam and supports the brake pad assembly, wherein the cam roller is received in the contact groove when the camshaft is in a second rotational position.

2. The brake assembly of claim 1 wherein the cam roller has a brake shoe engagement surface that engages the brake pad assembly and a cam engagement surface that engages the S-cam and is received in the contact groove when the camshaft is in the second rotational position.

3. The brake assembly of claim 2 wherein the brake shoe engagement surface is spaced apart from the cam engagement surface, the brake shoe engagement surface does not engage the camshaft, and the cam engagement surface does not engage the brake pad assembly.

4. The brake assembly of claim 2 wherein the cam roller extends along a cam roller axis and the brake shoe engagement surface and the cam engagement surface extend around the cam roller axis, wherein the cam engagement surface has a larger diameter than the brake shoe engagement surface.

5. The brake assembly of claim 4 wherein the cam roller has an intermediate surface that is disposed between the brake shoe engagement surface and the cam engagement surface, wherein the intermediate surface extends around the cam roller axis and the intermediate surface has a larger diameter than the brake shoe engagement surface and a smaller diameter than the cam engagement surface.

6. The brake assembly of claim 5 further comprising a first step surface that extends from the brake shoe engagement surface to the intermediate surface, wherein the first step surface engages the brake pad assembly to inhibit axial movement of the brake pad assembly with respect to the cam roller axis.

7. The brake assembly of claim 6 further comprising a second step surface that extends from the intermediate surface to the cam engagement surface, wherein the second step surface extends into the contact groove when the camshaft is in the second position.

8. The brake assembly of claim 1 the cam roller extends along a cam roller axis and includes:
a pair of cam roller end surfaces that extend from the axis and are disposed opposite each other;
a pair of brake shoe engagement surfaces, wherein each brake shoe engagement surface extends from a corresponding cam roller end surface; and
a cam engagement surface that is disposed between the pair of brake shoe engagement surfaces, wherein the cam engagement surface has a larger diameter than the brake shoe engagement surface.

9. The brake assembly of claim 8 wherein the brake pad assembly has a pair of webs, wherein each web engages a corresponding brake shoe engagement surface and the cam engagement surface is disposed between and spaced apart from the pair of webs.

10. A brake assembly comprising:
a spider;
a brake pad assembly that is moveably disposed on the spider;
a camshaft tube that is mounted to the spider;
a camshaft that is disposed in the camshaft tube and rotates about an axis to actuate the brake pad assembly, wherein the camshaft includes:
a shaft that is rotatably disposed in the camshaft tube and that has an outer shaft surface that extends around the axis; and
an S-cam disposed proximate an end of the shaft, the S-cam having an end surface, a first end wall that has a first arcuate surface that extends from the end surface, and a contact groove that extends from the first end wall toward the shaft, wherein the contact groove is disposed closer to the axis than the first arcuate surface and the outer shaft surface; and
a cam roller that engages the S-cam and the brake pad assembly, wherein the cam roller is not received in the contact groove when the camshaft is in a first rotational position and the cam roller is received in the contact groove when the camshaft is rotated from the first rotational position to a second rotational position.

11. The brake assembly of claim 10 wherein the cam roller is disposed closer to the axis when the camshaft is in the second rotational position than when the camshaft is in the first rotational position.

12. The brake assembly of claim 10 wherein the S-cam has a second end wall that extends from the shaft, wherein the first end wall and the second end wall cooperate to at least partially define the contact groove.

13. The brake assembly of claim 12 wherein the S-cam includes a contact surface that extends from the first end wall to the second end wall, wherein the cam roller engages the contact surface when the cam roller is disposed in the contact groove.

14. The brake assembly of claim 13 wherein the first wall has a first side surface that is disposed opposite the end surface and that extends from the first arcuate surface to the contact surface.

15. The brake pad assembly of claim 14 wherein the second wall has a second arcuate surface that extends from the shaft and a second side surface that is disposed opposite the shaft and that extends from the second arcuate surface to the contact surface.

16. The brake assembly of claim 15 wherein the cam roller is disposed between and spaced apart from the first side surface and the second side surface when the cam roller is disposed in the contact groove.

17. The brake assembly of claim 15 wherein the outer shaft surface is disposed further from the axis than at least a portion of the first arcuate surface and the second arcuate surface.

18. The brake assembly of claim 13 wherein the cam roller has a pair of brake shoe engagement surfaces and a cam engagement surface that is disposed between the pair of brake shoe engagement surfaces, wherein the cam engagement surface is the only surface of the cam roller that engages the camshaft.

19. The brake assembly of claim 18 wherein the cam engagement surface is disposed between the first end wall and the second end wall when the cam roller is disposed in the contact groove.

20. The brake assembly of claim 18 wherein the cam engagement surface engages the S-cam and is not disposed between the first end wall and the second end wall when the cam roller is not disposed in the contact groove.
